(19) United States
(12) Patent Application Publication
(10) Pub. No.: US 2018/0106509 A1
(43) Pub. Date: Apr. 19, 2018

(54) BACKPACK FOR USE WITH A PORTABLE SOLAR POWERED REFRIGERATION BOX AND WATER GENERATOR

(71) Applicant: Aldelano IP Holdings, LLC, Ontario, CA (US)

(72) Inventors: Alfred Hollingsworth, Ontario, CA (US); Nicole Smith, Grand Rapids, MI (US); Michael Goodwyn, Jackson, TN (US); Nicholos Rakestraw, Jackson, TN (US)

(21) Appl. No.: 15/839,605

(22) Filed: Dec. 12, 2017

Related U.S. Application Data
(63) Continuation of application No. PCT/US2016/037124, filed on Jun. 12, 2016.
(60) Provisional application No. 62/175,045, filed on Jun. 12, 2015.

(51) Int. Cl. F25B 27/00; F25D 11/00; F25D 11/02; F25B 1/00

(52) U.S. Cl. CPC F25B 27/002; F25D 11/003; H02J 3/385; F25B 1/00; F25B 2600/112; F25D 11/025

(57) ABSTRACT

A portable refrigeration unit includes a substantially rectangular box for providing storage for perishable goods. A refrigerator is used for cooling the rectangular box to a predetermined temperature. An insertable backpack engages within an open end of the substantially rectangular box for providing a supporting surface for components of the refrigeration unit. The portable refrigeration unit further includes a water generator for generating potable water from atmospheric moisture that can be heated using refrigeration components.

### CROSS-REFERENCE TO RELATED APPLICATIONS

This application claims priority under 35 U.S.C. § § 119(a) and 365(b) and is a continuation-in-part of PCT/US2016/37124 filed on Jun. 12, 2016 which claims priority to U.S. Provisional application Ser. No. 62/175,045 filed on Jun. 12, 2015.

### FIELD OF THE INVENTION

The present invention relates generally to portable refrigeration and more particularly to a self-powered portable refrigeration unit that can be transported to remote locations.

### BACKGROUND

A solar-powered refrigerator is a refrigerator that runs on energy directly provided by sun which may include photovoltaic and/or solar thermal energy. Solar-powered refrigerators are able to keep perishable goods such as meat and dairy cool in hot climates, and are used to keep much needed vaccines at their appropriate temperature to avoid spoilage. Solar-powered refrigerators may most commonly be used in the developing world to help mitigate poverty and climate change. Those skilled in the art will recognize that a solar powered refrigeration unit or “cold box” requires number mechanical and electrical control systems to enable its operation.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1A, 1B, 1C, 1D and 1E are perspective views illustrating an insert and equipment used in connection with a refrigerated cold box in accordance with some embodiments of the invention.

FIG. 2 is a block diagram of the refrigeration cold box system showing electrical, water generation and communications components.

FIG. 3 is a block diagram illustrating the solar and battery components of the electrical system.

FIG. 4 is block diagram illustrating a detachable water generator with heating and ice capability according to an embodiment of the invention.

FIG. 5A is a perspective view illustrating a bracket for adjusting the position of solar cells.

FIG. 5B is a perspective view illustrating the bracket of FIG. 5A in an extended position.

FIG. 5C is a perspective view illustrating the bracket of FIG. 5A in a folded position.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### SUMMARY OF THE INVENTION

A solar powered portable refrigeration unit has an insulated bay for storing perishable goods. An electrical controller controls solar cells, batteries and a petroleum powered generator for providing energy to the refrigeration unit where an inverter is used converting DC voltage from the battery to an AC voltage. The solar powered portable refrigeration unit includes a stand-alone, detachable water generation unit for converting atmospheric moisture to potable water at various temperatures. A detachable ice maker also works to freeze the potable water to provide ice. The solar powered portable refrigeration unit is particularly useful in hash environments providing disadvantaged persons or those suffering from acts of god to store perishable food or medicine while also providing potable water from atmospheric moisture without the use fossil fuels or a replenishable fuel source.

### DETAILED DESCRIPTION

Before describing in detail embodiments that are in accordance with the present invention, it should be observed that the embodiments reside primarily in combinations of method steps and apparatus components related to a self-powered off-grid refrigeration box. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It is expected that one of ordinary skill, notwithstanding possibly significant effort and many design choices motivated by, for example, available time, current technology, and economic considerations, when guided by the concepts and principles disclosed herein will be readily capable of generating such mechanical solutions, software instructions and programs with minimal experimentation.

Traditionally, solar-powered refrigerators and vaccine coolers use various types electrical systems to power these devices. These devices use solar panels and batteries to store energy for cloudy days and for use at night, in the absence of sunlight, to keep their contents cool. Moreover, solar power refrigeration units have been small in size, at approximately five cubic feet (5 ft³) or less. Thus, this limits the amount of storage when larger amounts of food or vaccine are to be stored. These problems and the resulting higher costs have been an obstacle for the use of solar powered refrigerators in developing areas.

In using larger solar powered refrigeration systems, transforming the device to for operation in remote and underdeveloped areas can be challenging. For example, large scale refrigeration systems are extremely power consumptive and inefficient. In many cases, these systems were designed for work with AC mains, and in some cases 3-phase power systems, and do not lend themselves to being powered by a solar energy system or petroleum generator on a long term or ongoing basis. Transporting a large refrigerator box to remote locations, intact with all necessary devices and controls, can become impractical. Consequently, new types of technological solutions must work to accommodate these situations.

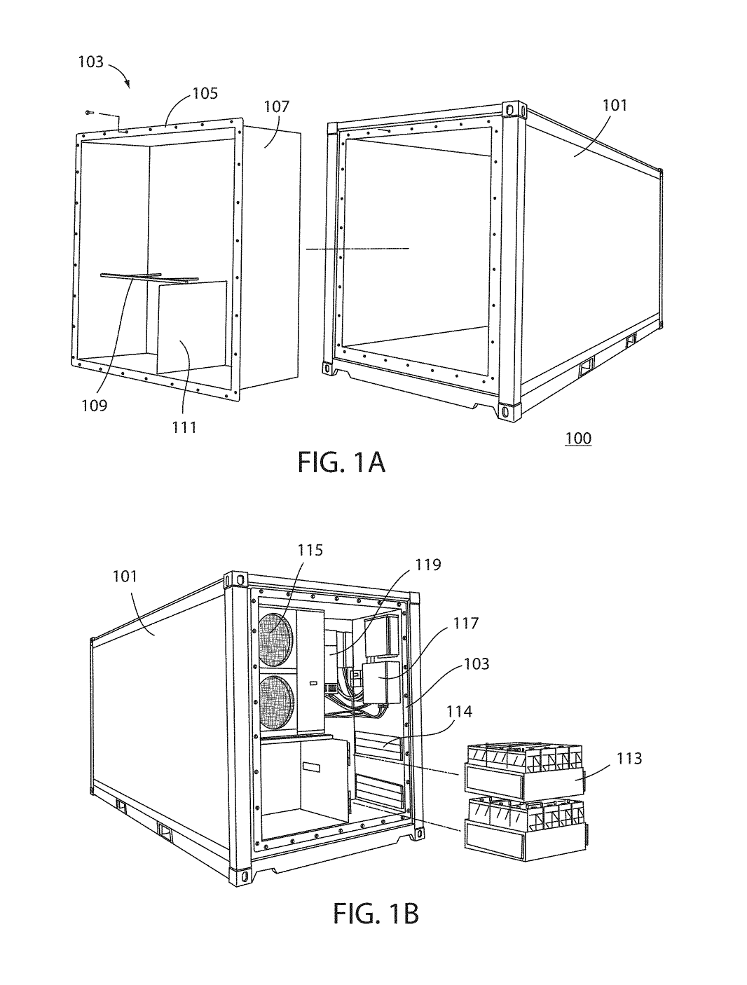

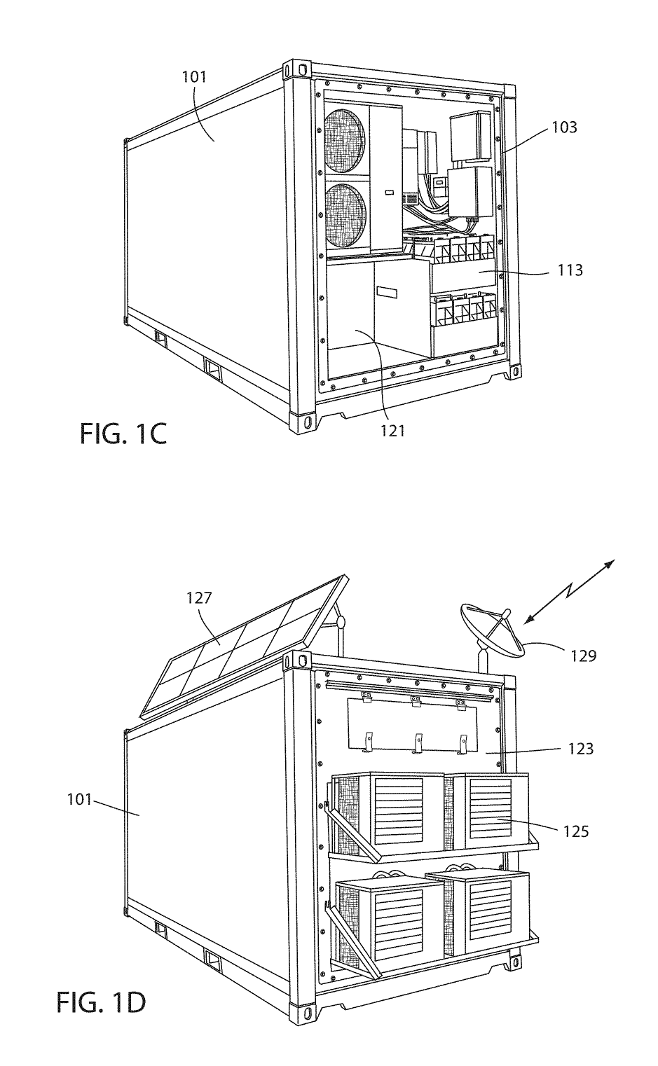

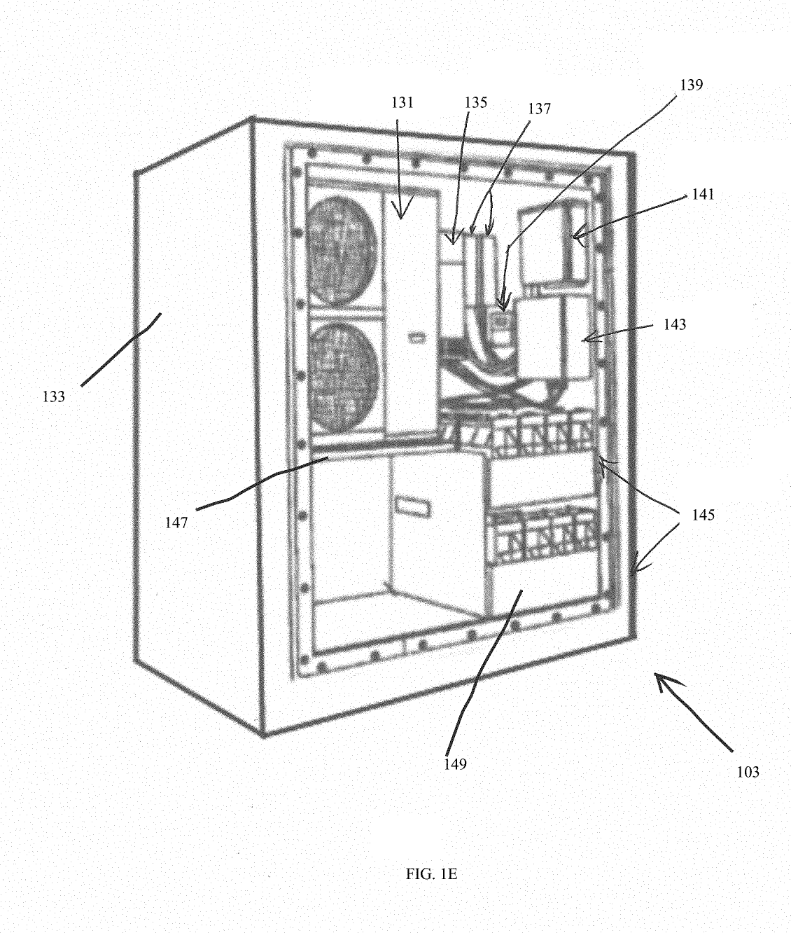

FIG. 1A is an exploded view illustrating the use or an insert or “backpack” assembly used in connection with a refrigerated cold box. The backpack assembly 100 includes the cold box 101 and a backpack 103. The backpack 103 is substantially rectangular in shape and includes a lip or mounting flange 105 around its perimeter. The cold box 101 and backpack 103 are sized so that the rear side 107 of the backpack frictionally engages within and into the front opening of the cold box 101. The mounting flange 105 abuts the perimeter of the front opening, and it contains the same ISO bolt hole pattern as found on the cold box reefer container. It is secured to the cold box with screws or other mechanical fasteners. In one embodiment, the backpack 103 provides a sealed environment for the cold air temperatures used within the cold box 101. The backpack 103 further includes one or more shelves 107 and dividing panels 111 facing outwardly from the interior of the cold box, that are used to hold and/or support the control and electrical components. The backpack 103 may be recessed inside the unit as shown, or alternatively may extend outside of the unit. In another embodiment, the backpack may be figured in a “frame style” backpack for the recessed unit with a framed perimeter supporting shelving and the like. In still another embodiment, the equipment compartment can be configured directly inside of the cold box container without a “backpack” structure while using an insulated wall to separate the equipment compartment from the cooler, cold box portion of the container. In this scenario, a frame structure would be used or shelving and other components would be attached to a portable floor section that is dropped into the container. Those skilled in the art will recognize the equipment compartment can be made from metal, wood, plastic or other materials that are rigid and capable of supporting mechanical and electrical control components.

FIG. 1B is a perspective view illustrating the backpack 103 inserted into the refrigerated cold box 101. The backpack 103 is shown configured where a plurality of batteries 113 are to be inserted to a bracketed compartment 114 that works like a drawer. A generator unit 115, typically using fossil fuels, is mounted within the backpack 103 for providing a charging voltage to batteries 113 when needed. In an alternative embodiment, the generator unit 115 can be positioned on a sliding shelf that pulls out and away from the backpack 103 similar to the batteries. Since the generator does need more ventilation, once the unit is in a stable position, the generator can remain in a “slide out” position. In order for the doors on the back of the backpack to stay closed, the left side may have the door separated into 2 halves (top and bottom) so that the top can stay closed and locked while the bottom remains open to accommodate the generator being in the extended position.

Further components used in the cold box 103 include a DC to AC voltage inverter 117 and a control panel for controlling operation of the compressor unit 115 and charging of the battery pack(s) 113 when needed. Any electrical boxes can be mounted on a vertical slide-out panel to conserve space as opposed to mounting them directly to the walls. Although not shown, an evaporator is mounted to the back of the backpack on the inside of the refrigerated cold box 101. Further, hot gas defrost can be used to defrost the cold box which prevents accumulation of rime ice although those skilled in the art will recognize that either hot gas or an electric defrost can be used for this purpose.

FIG. 1C is a perspective view illustrating the backpack 103 inserted into the refrigerated cold box 101 and the battery pack 113 mounted within the backpack 103. A compartment 121 is used for housing additional control equipment when needed such as a water generator, ice maker and/or communications equipment.

FIG. 1D is a perspective view illustrating an optional embodiment where the backpack 103 inserted into the refrigerated cold box 101. A cover 123 is used to protect the components within the backpack 103. On the outer surface of panel 123, a plurality of compressor units 124 are used to cool the inside of the cold box 103 to some predetermined temperature typically below 40 degrees Fahrenheit (4 degrees C.). In this embodiment, solar cell panels 127 are shown mounted to the top of the cold box 101 although they may be mounted separately at ground level. Finally, a satellite antenna 129 may also be mounted atop the cold box 101 and is used for connecting to communications equipment for providing remote communication and Internet service via transceiver mounted in the backpack 103. Those skilled in the art will further recognize that the backpack 103 also may be hinged at its side or at the top so that it can be moved to open the end of the cold box 101. Moreover, the end of the backpack 103 can include a door or other cover for protecting the outwardly facing components. A retractable stairway or pivotable climbing stairs may also be used with the backpack 103 for enabling users and/or technicians to climb to an appropriate level for gaining access to components with in backpack 103.

FIG. 1E is a perspective view illustrating an alternative embodiment of the backpack 103 that sits on the ground or raised surface rather than next to a cold box. This backpack differs in that it is designed to complement an already existing cold box or cold room. In use, an evaporator will be installed inside the cold room and connected to a condensing unit inside the backpack. An advantage in using this embodiment is that the backpack will increase the energy efficiency of the upgraded cold box, powered from solar, without using any preexisting refrigeration equipment and/or connection to the power grid. As seen in FIG. 1E, a condensing unit 131 is mounted inside the backpack housing 133. As described herein, the backpack 103 also includes an inverter 135, charge controller(s) 137, inverter controller 139 for converting DC solar voltages to AC voltages. A combiner box 141 controls the combination of AC and DC voltages. A breaker box 143 provides control for over current and voltage while a battery bank 145 stores energy from one or more solar panels. A plurality of adjustable or removable shelves 147 and/or drawers 149 can be used within the cold box 103 to facilitates storage and access to these components for easy servicing.

Thus, the embodiment as shown in FIG. 1E is a standalone solar powered electronic control and refrigeration unit that can connected to an existing cold room (e.g. and insulated room or container). The backpack operates so as to convert an existing cold room to solar powered refrigeration station. It can be independent shipped from the cold room and can be easily moved using a forklift and so it is easier to transport to remote areas

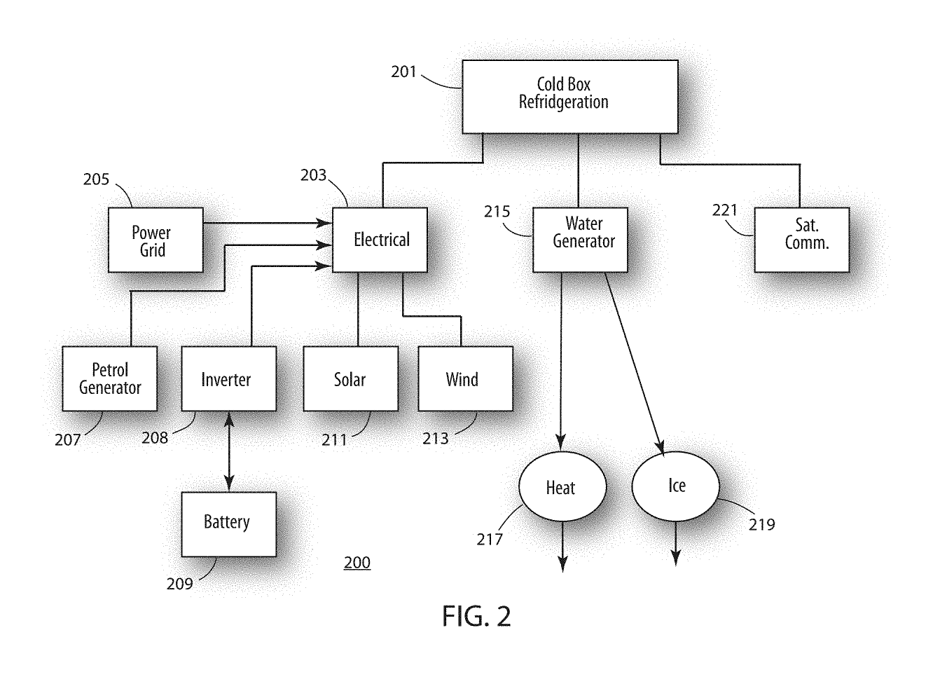

FIG. 2 is a block diagram of the overall configuration of the cold box system according to an embodiment of the invention. The cold box system 200 includes a refrigeration unit 201 that typically is heavily insulated, with foam and stainless-steel sheeting, for maintaining a predetermined cold temperature within the box in a hot ambient environment. An electrical system 203 is used in connection with the refrigeration unit 201 and includes controls for a main power grid input 205, a petrol generator 207, a battery 209, solar cells 211, or an optional wind generator 213. In one embodiment, the generator 207 has been converted from a three-phase power system to a single phase power system for use with the inverter 208. Although the battery provides the DC power, an inverter 208 is used to provide AC power to the refrigeration unit 201. Thus, the electrical system 203 operates to control various sources of electrical energy for providing power to the entire refrigeration system 200.

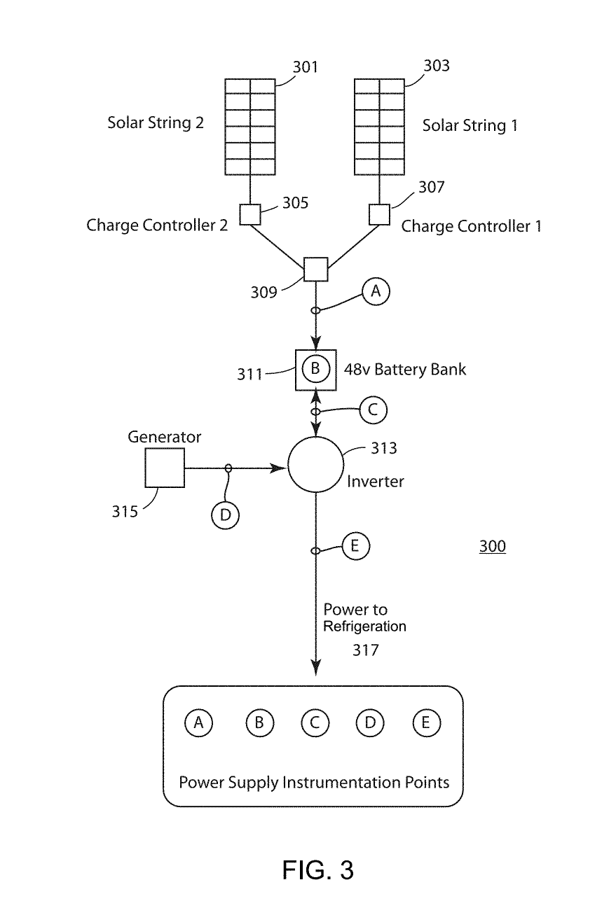

FIG. 3 illustrates embodiments of the power supply system for use with the refrigerated cold box. The cold box consists of the following components. a) a group of 24 solar panels each rated at 315 watts peak power output and arranged in two strings of 12 panels. The rated output power of solar array is then over 7 KW. The design point for solar insolation is typically six hours of rated output per day (6 hrs/day) as an annual average. Hence, on an annual basis this power supply will produce over 45 KW-hr per day of operation. b) each solar panel string charges the battery bank using a charge controller. A charge controller might typically be one manufactured by Maximum Power Point Technology (MPPT) although others may also be used. These devices ensure that the solar panels are always operating at peak power and that the maximum power is delivered to the battery bank; c) a battery bank that consists of 24-each high capacity 2-volt flooded-cell lead-acid storage batteries. At 50% state-of-charge this battery bank provides over 27 KW-hr of energy storage. d) a smart inverter converts the DC battery power to the 230-volt single-phase AC power required by the refrigeration system; e) a backup power generator capable of operating the refrigeration equipment and charging the batteries and operates using gas, fossil fuels or a replenishable fuel source; and the refrigeration equipment consumes approximately 6 KW when operating. A duty cycle of 30% has been assumed leading to over 43 KW-hr of daily energy consumption. Those skilled in the art will recognize that he number of panels and batteries may vary depending on the overall size of the box. A smart inverter is used for detecting when batteries have discharged to pre-set levels which then automatically switches to the petrol generator as an alternate power source (or can switch to AC main grid-power if hooked to the grid). When batteries have recharged, the inverter will automatically switch back to battery power.

In use, on a typical day with solar insolence at the design point, the solar panel array and MPPT controllers will charge the batteries and operate the refrigeration equipment during daylight hours. After sunset, when the solar array is no longer providing power, the refrigeration equipment will operate totally from battery storage until sunrise at which point the solar array will recharge the batteries and operate the refrigeration equipment. In use, the battery bank is designed to fully support the refrigeration for approximately 15 hours of operation. However this is a conservative estimate since during night operations and rainy-day operations the thermal load is expected to decrease. During times of normal solar day s and design point refrigeration operation the system will be 100% solar powered. If sufficient solar energy is not available and the battery bank voltage drops below the 50% state-of-charge set point the back-up generator will start. The generator start is controlled by the smart inverter. The generator will operate the refrigeration equipment and simultaneously recharge the batteries. When the battery bank has reached 100% state-of-charge, the inverter control system will shut down the generator and the system will return to battery operation. An important aspect of the invention is that during times of generator operation, the current path is both to the load and to recharge the batteries. This allows the generator to operate at the maximum efficiency point and will minimize fuel consumption and generator operating time. It also prevents “short-cycling” the generator. Data logging will be accomplished through the inverter. This will assist in control algorithm refinement for various types of installation sites.

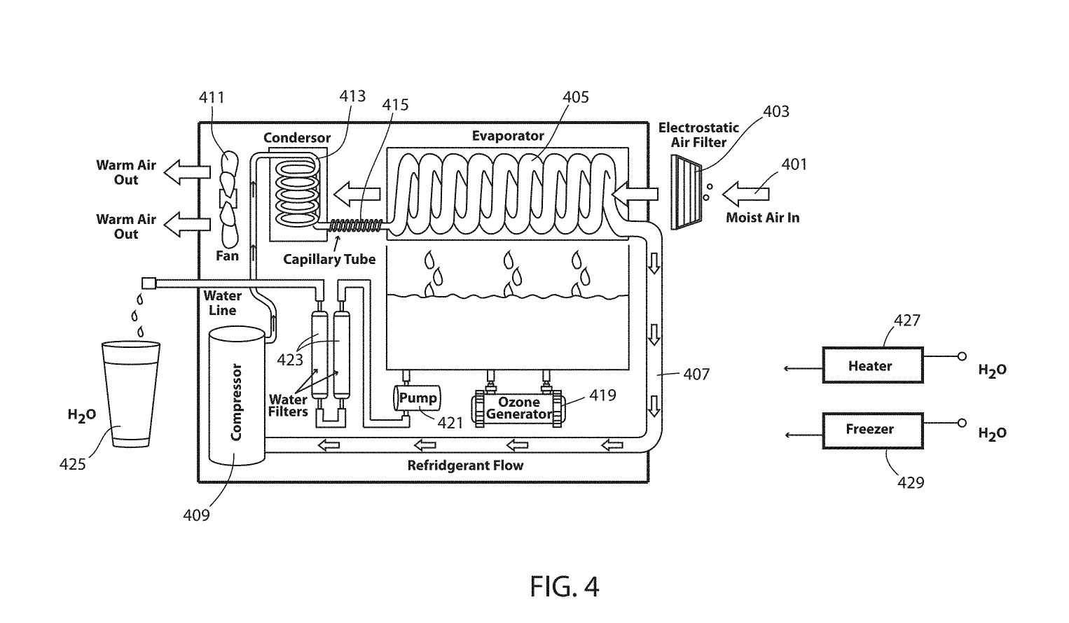

FIG. 4 is block diagram illustrating an atmospheric water generator with heating and ice capability according to an embodiment of the invention. An atmospheric water generator (AWG). An AWG is a device that extracts water directly from moist ambient air. Water vapor in the air is condensed by cooling the air below its dew point, exposing the air to desiccants, or pressurizing the air. Unlike a dehumidifier, an AWG is designed to render the water potable. AWGs are useful where pure drinking water is difficult or impossible to obtain, because there is almost always a small amount of water in the air that can be extracted. Research has developed AWG technologies to produce useful yields of water at a reduced energy cost.

Many atmospheric water generators operate in a manner very similar to that of a dehumidifier where air is passed over a cooled coil, causing water to condense. The rate of water production depends on the ambient temperature, humidity, the volume of air passing over the coil, and the machine's capacity to cool the coil. These systems reduce air temperature, which in-turn reduces the air's capacity to carry water vapor. This is the most common technology in use, but when powered by coal-based electricity it has one of the worst carbon footprints of any water source (exceeding reverse osmosis seawater desalination by three orders of magnitude) since it demands more than four times as much water up the supply chain as it delivers to the user.

As seen in FIG. 4, in a cooling condensation type atmospheric water generator 400, mounts air 401 is filtered 403 through and electrostatic filter or the like. This air is passed over an evaporator 405 and on to a condenser coil that exits the generator using a fan 411. Air passing over the evaporator 405 causes condensation which is collected by a holding tank 417. The water in the holding tank 417 may be cleaned using an ozone generator 419 after which it can be pumped 421 from the tank to a water filter 423. Thereafter the water 425 is potable and can be used for drinking or the like. In one embodiment, the water generator 400 can be self-powered allowing the water generator to be detachable and portable in situations where it must operate independently of the refrigerated cold box.

In order to condense the water in the air, a compressor 409 circulates refrigerant in pipe 407 through a condenser 413 and then an evaporator coil 405 which cools the air surrounding it. This lowers the air temperature to its dew point, causing water to condense. A controlled-speed fan 411 pushes filtered air over the evaporator coil 405. The resulting potable water is then passed into the holding tank 417 where a purification and filtration system, such as ozone generator 419 keep the water pure and reduce the risk posed by viruses and bacteria which may be collected from the ambient air on the evaporator coil by the condensing water.

The rate at which water can be produced depends on relative humidity and ambient air temperature and size of the compressor. Atmospheric water generators become more effective as relative humidity and air temperature increase. As a rule of thumb, cooling condensation atmospheric water generators do not work efficiently when the temperature falls below 18.3° C. (65° F.) or the relative humidity drops below 30%. This means they are relatively inefficient when located inside air-conditioned offices. The cost-effectiveness of an AWG depends on the capacity of the machine, local humidity and temperature conditions and the cost to power the unit. Once potable water is produced, the water can be heated using a heating unit 427 or can be frozen to produce ice using a freezing unit 429. Since the refrigeration process involves a compressor heating the refrigerant to create a hot gas, and sending it to the condenser which cools the gas to a liquid. In this process, heat is expelled around the condensing coil that can be captured and used in connection with a heat exchanger to heat the potable water prior to the heat being expelled from the system.

Additionally, a temperature sensor can be inserted in the condensing coil that will turn the compressor off when the coil temperature gets close to a predetermined temperature e.g. freezing. Variable speed fan technology can be used to vary the compressor fan speed to maintain the condensing coil at a specific temperature that should be slightly above freezing and always below the dew point. This will allow the water generator to operate in marginal conditions regardless of the environment. Moreover, the dew point can be calculated allowing the water generation unit to operate only when it is practical to do so, regardless of the climate or location of the refrigeration unit. Further, the refrigeration unit uses software that can “learn” when the most moisture is available in a 24-hour period and maximize its water production during that period.

In still another embodiment, using only one blower, the cool air from the unit's evaporator will pass through the condenser, so to vary the air volume through two air coils independently of one other. A highly efficient, variable speed blower motor can be used with software control. This enables more water to be produced at lower wattage with less stress on the unit's compressor. In still other embodiments, the refrigeration system and the water treatment/storage system may be two separate units where the refrigeration portion of the unit is a separate “self-contained” unit. The water generator might be built from lightweight aluminum with handles on both sides so it can be easily transported or moved. It can then be placed on a elevated platform. This would allow the water it produces to gravity flow (without the need for a pump) into a self-contained” holding tank and treatment system at a lower level. This water could then be pumped through a filtration and sterilization system into a holding tank. In still another embodiment, the refrigeration and water generation units can vary in capacity so as to match the “available” electrical power stored in the containers batteries, when full power is not available.

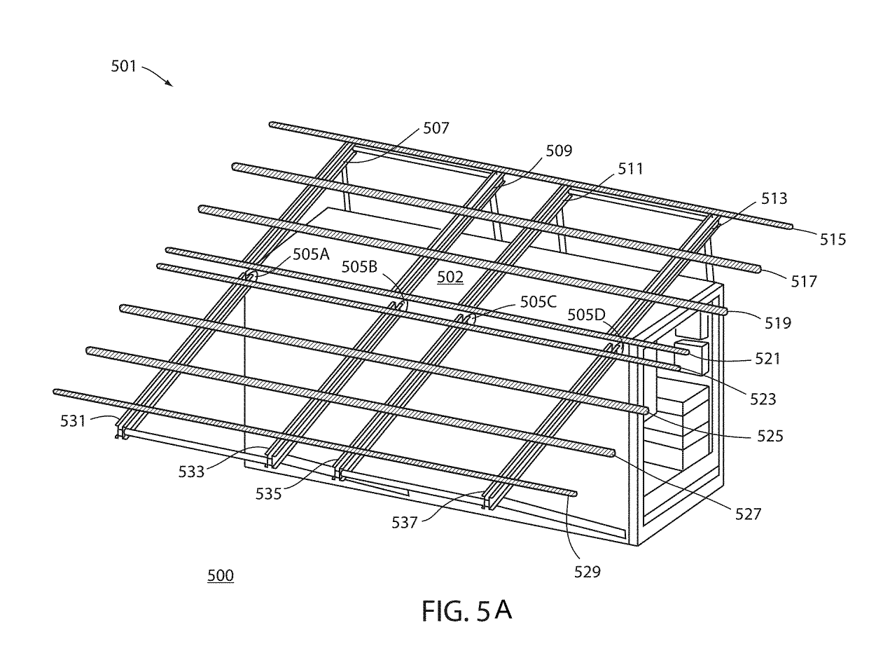

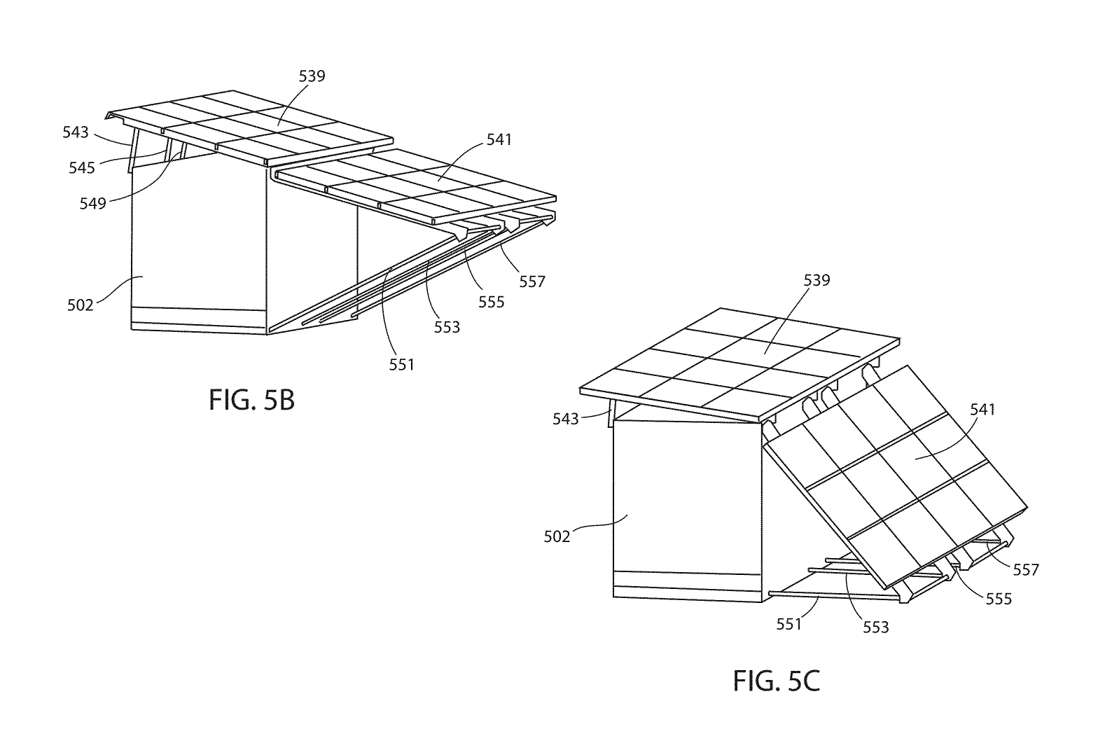

FIG. 5A illustrates a bracket for adjusting the position of solar cells. The bracket 500 includes an upper section 501 and lower section 503 that are joined using a plurality of hinges 505a, 505b, 505c, 505d that allow the upper section 501 and lower section 503 to bend relative to one another. The upper section 501 and lower section 503 are positioned over the top and/or side of refrigeration unit or cold box 502. The upper section 501 includes a bracket having a plurality of vertical members 507, 509, 511, 513 the cross at substantially right angles with horizontal members 515, 517, 519, 521 to form the upper supporting bracket. The upper supporting bracket is configured into a matrix that is used to support one or more solar panels. The vertical members and horizontal members can be made from steel rod or tubular aluminum for supporting the weight to the solar panels. As seen in FIG. 5A, the vertical members 507, 509, 511 and 513 can be doubled with two or more tubes to enhance overall strength. Similarly, the lower supporting bracket 503 includes vertical support members 523, 525, 527 and 529 and horizontal support members 531, 533, 535 and 537 that also cross one another to form a matrix configuration for supporting one of more solar panels positioned below the upper bracket 501. The hinges 505 joint the upper bracket 501 and lower bracket 503 and are typically positioned at the edge between the top and side of the refrigeration unit 502.

FIG. 5B is a side view of the refrigeration unit illustrating the bracket of FIG. 5A in an extended position. An upper solar panel 539 is shown connected by hinges to the lower solar panel 541. A top or upper edge of the upper solar panel 539 is connected a plurality of telescoping adjustable supports 543b, 545b, and 549b. Although three supports are shown those skilled in the art will recognize that only one support could be used if the panels are contiguously attached. Each adjustable support is telescoping so that its overall length can be easily adjusted and locked into a fixed position. The support works to adjust the solar panel 539 so as it adjusts its angle of incidence so that it more directly faces the sun. Similarly, the lower solar panel 541 also includes adjustment supports 551b, 553b, 555b and 557b. Although four supports are shown, those skilled in the art will recognize that one support may be used depending on size and weight of the solar panel 541. The locking action of the adjustable supports will be controlled by threaded sections, fasteners or frictionally engaging different sections based on the overall gauge of the tubes used in construction.

FIG. 5C is a side view of the refrigeration unit illustrating the bracket of FIG. 5A in a folded position. In FIG. 5C, the solar panel 539 is atop the refrigeration unit 502 where the adjustable support 543c is shown in a retracted or shorter position such that the solar panel 539 faces more closely to zenith or straight upward in the sky. The solar panel 541 and its adjustable supports 551c, 553c, 555c and 557c are shown more retracted so the solar panel 541 faces more closely to the horizon. The advantage of using the adjustable supports allows the solar panels to be maximized for directly incidence to sunlight regardless of the sun's position based on the time of year and/or geographical location of the refrigeration unit 502.

Still other embodiments of the invention as described herein include a modified generator that enables a cold start automatically/unassisted utilizing a built an automatic choke. A converted generator wiring to work with inverter (converted 3 wire systems to 2 wire). A modified electric defrost condensing unit that operates using a hot gas bypass defrost evaporator by adding hot gas bypass circuit to condensing unit. A “soft start” to the condenser to allow it to start with low energy supply. Finally, a heat exchange process for allowing the high side line and the low side line (that connects between the condenser and evaporator) to make physical contact for a determined length for the purpose of keeping the pressures in the line sets from rising in the when the outside ambient air pressure increases.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A backpack for use with a refrigerated cold box comprising:
a substantially square frame having a mounting lip surrounding its perimeter;
a hollowed area configured within the frame for mounting control components of the refrigerated cold box; and
wherein the square frame is sized to be inserted within an end of the cold box allowing the mounting flange to be fastened to the cold box.

2. A backpack as in claim 1, wherein a bolt pattern on the mounting flange matches that of the refrigerated cold box.

3. A backpack as in claim 1, further comprising at least one shelf configured within the hollowed area for providing a mounting surface for the control components.

4. A backpack as in claim 3, wherein the control components include:
an electrical controller for controlling refrigeration components;
at least one battery; and
at least one petroleum powered generator.

5. A backpack as in claim 1, wherein the refrigeration cold box further comprises a detachable water generation unit and ice maker.

6. A backpack or use with a solar powered portable refrigeration unit comprising:
an insulated cold box for providing storage for perishable goods;
a refrigerator for cooling the cold box to a predetermined temperature; and
a backpack configured within an open end of the cold box for providing a supporting surface for components of the refrigeration unit where the backpack is sized to be inserted within the open end of the insulated cold box and faces outwardly for facilitating mounting of operating components.

7. A backpack as in claim 6, wherein the backpack includes at least one shelf for supporting the components.

8. A backpack as in claim 6, further comprising:
at least one battery for providing power to the refrigerator; and
at least one solar cell for charging the battery.

9. A backpack as in claim 6, further comprising:
at least one battery; and
an inverter for converting DC voltage from the battery to an AC voltage to power the refrigerator.

10. A backpack as in claim 6, wherein the cold box further includes a removeable water generator for generating potable water from atmospheric moisture.

11. A backpack as in claim 10, wherein the potable water can also be heated using refrigerator components.

12. A backpack as in claim 6, wherein the insulted cold box further comprises a removeable ice maker for generating ice from atmospheric moisture.

13. A backpack as in claim 6, wherein the backpack includes a mounting flange around its perimeter that match an ISO bolt pattern of the cold box.

14. A solar powered cold box system using a backpack control comprising:
a cold box having an insulated bay wherein an interior of the cold box is provided with refrigerated air below a predetermined temperature from a refrigerator;
a separable water generation unit for converting atmospheric moisture to potable water at various temperatures;
a separable ice maker for freezing the potable water; and
a backpack configured to inserted within an end of the cold box for providing a mounting surface for control systems of the cold box.

15. A solar powered cold box as in claim 14, wherein the backpack is configured into a hollowed rectangular shape for providing a separate enclosure facing outwardly from the cold box.

16. A solar powered cold box as in claim 14, wherein the backpack is configured to hold an inverter, at least one battery and a gasoline powered generator.

17. A solar powered cold box as in claim 14, wherein the backpack is configured to hold the refrigerator.

18. A solar powered cold box as in claim 17, wherein the cold box is mobilized though the use of a wheeled trailer.
